(19) United States
(12) Patent Application Publication
(10) Pub. No.: US 2009/0208216 A1
(43) Pub. Date: Aug. 20, 2009

(54) Dispersion compensation

(76) Inventors: Andrew Ellis, County Cork (IE); Mary McCarthy, County Cork (IE)

Correspondence Address: JACOBSON HOLMAN PLLC, 400 SEVENTH STREET N.W., SUITE 600, WASHINGTON, DC, 20004, US

(21) Appl. No.: 11/921,764

(22) PCT Filed: Jun. 8, 2006
(86) PCT No.: PCT/IE2006/000063

§ 371 Date: Dec. 7, 2007

(30) Foreign Application Priority Data
Jun. 8, 2005 (IE) 2005/0388

(51) Int. Cl. H04J 14/02

(52) U.S. Cl. 398/81

(57) ABSTRACT

A dispersion compensation system comprises a detector for receiving an optical input signal and a compensator for processing the detector outputs and re-constituting the original signal. The detector generates at least two signals which depend on the instantaneous amplitude and frequency of the distorted signal in different ways, and the compensator electrically processes the detector outputs. The detector comprises a wavelength selective device (such as an asymmetric MZI) and two or more opto electronic detectors providing the electrical signals. The detector subtracts outputs of the MZI to provide frequency information and sums MZI outputs to provide amplitude information. The detector may have a dedicated amplitude detector. The compensator may have a local oscillator which is modulated by amplitude and phase or frequency information of the detector output signals, and the local oscillator may operate in the range of 11 to 100 GHz.

### FIELD OF THE INVENTION

The invention relates to compensation for dispersion in optical signals.

### PRIOR ART DISCUSSION

Optical communication systems are often subject to forms of signal degradation, including: chromatic dispersion, non-linearity and polarisation mode dispersion. Compensation for these impairments may be provided either optically or electronically. Increasingly, the need for tuneable compensation is becoming apparent for the highest performance levels, particularly for high bit rate wavelength division multiplexed (WDM) systems. This compensation tuning is often required on a channel-by-channel basis. For example, in a long haul transmission system, the accumulated dispersion varies strongly from channel to channel and within an optical network. Furthermore the signals present at any point in the network may have propagated over different paths, and these paths may change over time (due for example to network reconfiguration, routing, dynamic fault restoration and provisioning). The dispersion compensation of each specific channel often makes optical solutions expensive and/or impractical, and considerable effort is directed at electronic techniques.

Electric dispersion compensation techniques involve the detection of the distorted optical signal, followed by a number of possible electrical filters. These filters include (i) finite impulse response (FIR) filters, with a four tap filter being a common implementation, (ii) decision feedback filters (DFE), where the output from a FIR filter is passed through a decision gate and injected into the input of the filter with an appropriate amplitude and delay, and (iii) maximum likelihood sequence estimators (MLSE), where a digital signal processing (DSP) circuit is used to choose the pattern which would be most likely to have resulted in the received waveform. The implementation of the MLSE requires multi-level, high-speed analogue to digital conversion, and a high level of electronic processing which while complex is relatively cheaply available. However, the signal that is electronically processed or matched is the result of a direct detection of the incident optical signal power using a photodiode. This detection process is sensitive only to the amplitude (and not the phase) of the incoming optical signal, and so, unlike optical compensation, state of the art electronic compensators do not work for arbitrary distortion of the amplitude and phase of the signal.

An alternative means of electronic compensation was proposed, using coherent heterodyne detection and micro strip line dispersion compensation. Coherent heterodyne detection, which is achieved by mixing the incoming optical signal with the output of a precisely controlled local continuous wave laser, gives an electrical signal output which is proportional to the electric field of the incoming signal rather than the power (proportional to the square of the field). Consequently the phase information of the optical signal is reproduced in the electrical domain. Heterodyne detection may be viewed as a down conversion process from an optical carrier frequency (e.g. 193 THz for an optical carrier with 1.55 μm wavelength) to an intermediate frequency in the GHz region. The down converted signal may be passed through a dispersive electrical component that would compensate the dispersion occurring in the optical domain. This was achieved using micro strip transmission lines. In principle, such an approach could compensate for arbitrary levels of optical dispersion and could also be made tuneable, using an appropriate tuneable electronic filter and/or a tuneable intermediate frequency. However, the heterodyne detection scheme requires a high performance local laser which is precisely locked to the optical frequency of the incoming signal plus a fixed offset corresponding to the intermediate frequency. The system is strongly polarisation sensitive (unless a costly and complex scheme such as polarisation diversity is used) and is strongly wavelength sensitive (unless a costly tunable laser is used). Thus such systems involve complex and costly optical subsystems.

US2003/0202743 describes an optical wavelength dispersion compensating filter comprising serially-interconnected Mach-Zehnder interferometers (MZIs). It appears that this approach is complex because of the number of MZIs (five in the one example), and the MZIs may add insertion loss. Also there may be non-linearity, as shown in FIG. 14 of this document.

An object of this invention is to provide an increased range of tuneable dispersion compensation when compared to current electronic dispersion compensators. Another object is to avoid the high complexity of the coherent detection.

### SUMMARY OF THE INVENTION

According to the invention, there is provided a dispersion compensation system comprising a detector for receiving an optical input signal and a compensator for processing the detector outputs and re-constituting the original signal, characterized in that,
the detector generates at least two signals which depend on the instantaneous amplitude and frequency of the distorted signal in different ways; and
the compensator electronically processes the detector outputs.

The term “electronically” is intended to mean that the compensator processes the detector outputs in the electrical domain.

In one embodiment, the detector comprises a wavelength selective device and two or more opto-electronic detectors providing the electrical signals.

In another embodiment, the wavelength selective device comprises an asymmetric MZI.

In a further embodiment, the detector subtracts outputs of the MZI to provide frequency information.

In one embodiment, the detector sums MZI outputs to provide amplitude information.

In one embodiment, the detector comprises a dedicated amplitude detector.

In one embodiment, the compensator comprises a local oscillator which is modulated by amplitude and phase or frequency information of the detector output signals.

In one embodiment, the local oscillator operates in the range of 11 to 100 GHz.

In one embodiment, the local oscillator comprises a laser device.

In one embodiment, the amplitude modulation in the compensator is non-linear, and the non-linearity is engineered to improve performance.

In a further embodiment, frequency modulation is performed in a separate device of the compensator.

In one embodiment, said device is an I/Q modulator, a double balanced mixer, or an acousto-optic device.

In one embodiment, the compensator comprises a phase modulator for converting frequency information to phase information prior to modulation of the local oscillator.

In one embodiment, the phase modulator comprises a device with a Kerr non-linearity.

In one embodiment, the phase modulator comprises a semiconductor device.

In one embodiment, the local oscillator is directly frequency modulated by a detector output signal.

In one embodiment, the local oscillator is a voltage controlled oscillator; a current controlled oscillator; or a semiconductor laser, preferably with the alpha parameter greater than 4.

In one embodiment, the compensator transmits the modulated local oscillator along a dispersive transmission line such as a micro-strip, an amplifier, an optical fibre, a grating, and/or an FIR filter.

In one embodiment, the compensator comprises a two-input electrical filter, such as a pair of cross-coupled FIR filters, or a DSP such as an FPGA.

In one embodiment, the compensator comprises a two-input electrical processing unit with past state- or sequence-based decision making such by executing an MLSE algorithm.

In one embodiment, the filter simulates the performance of a local oscillator.

In one embodiment, the compensator processes the outputs of the detector to provide signals proportional to the amplitude and frequency of the distorted signal, and re-constitutes the original signal using the processed signals.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a diagram of an opto-electronic interface of a compensation system of the invention;

FIGS. 2, 3, and 4 are diagrams of compensators;

FIG. 5 is a plot showing variation in Q factor as a function of transmission distance; and

FIG. 6 is a set of plots showing variation in penalty as a function of normalised dispersion.

### DESCRIPTION OF THE EMBODIMENTS

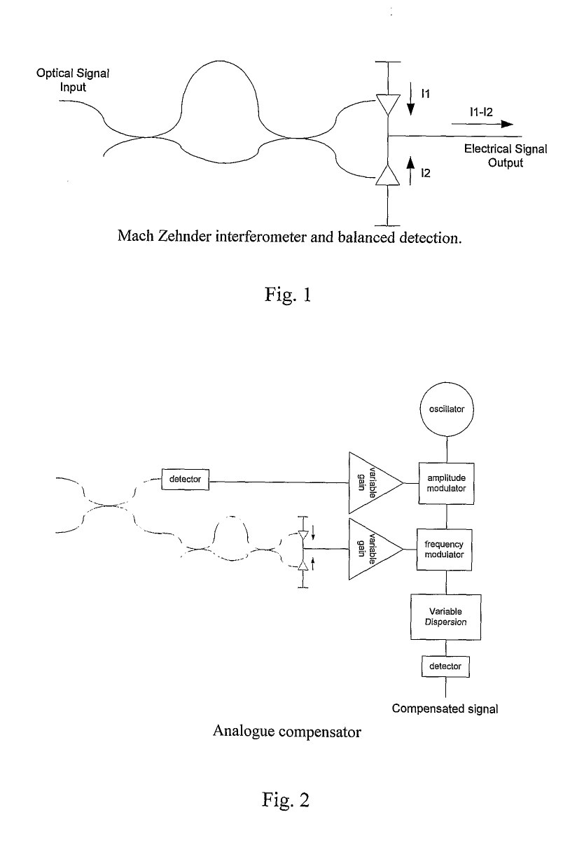

Referring to FIG. 1 an asymmetric Mac Zehnder Interferometer (MZI) is used for recovery of both completed and phase information from an optical signal, without significant constraints on signal polarisation or wavelength.

The interferometer gives a signal similar to the differential of the optical phase, or even the instantaneous optical frequency with respect to a fixed offset. Therefore, using the balanced circuit of FIG. 1 it is possible to recover a signal directly related to the instantaneous frequency of the optical signal, multiplied by its amplitude and a conventional photo detector to recover a signal proportional to its amplitude (or power). Alternatively, one can connect each of the photo-detectors shown in FIG. 1 to an independent amplifier, and subsequently obtain the difference between the outputs of these amplifiers (proportional to the signal frequency times the amplitude) and the sum of the outputs (proportional to the signal amplitude). This reduces the number of photo-detectors required from 3 to 2 in the compensators described below.

The compensator uses this amplitude and frequency information in the process of electronic compensation of the dispersion of the optical signal, to achieve significantly improved compensation.

### Analogue Techniques

Referring to FIG. 2, in order to compensate for chromatic dispersion, the output signals from the optical circuit, which are proportional to the amplitude and frequency of the incoming optical signal may be used to modulate a well defined local carrier signal in amplitude and phase. Appropriately configured, this produces a replica of the incoming optical signal. One way of implementing an analogue technique for an electrical dispersion compensator is represented in FIG. 2. The output of the first photodiode (power detection) is used to drive an amplitude modulator, while the output of the differential detector is used to drive a frequency modulator with an appropriate phase, thus generating a down-converted version of the signal. Finally, this converted signal is launched into a dispersive transmission line, with the opposite sign of the optical dispersion, and then demodulated to base-band (or detected), to give the compensated signal. Various tuning options are available, including variations in the amplitude of the both modulators driving signals, variations of the dispersion coefficient of the transmission line, and for appropriately designed dispersive transmission lines, variations of the oscillator central frequency.

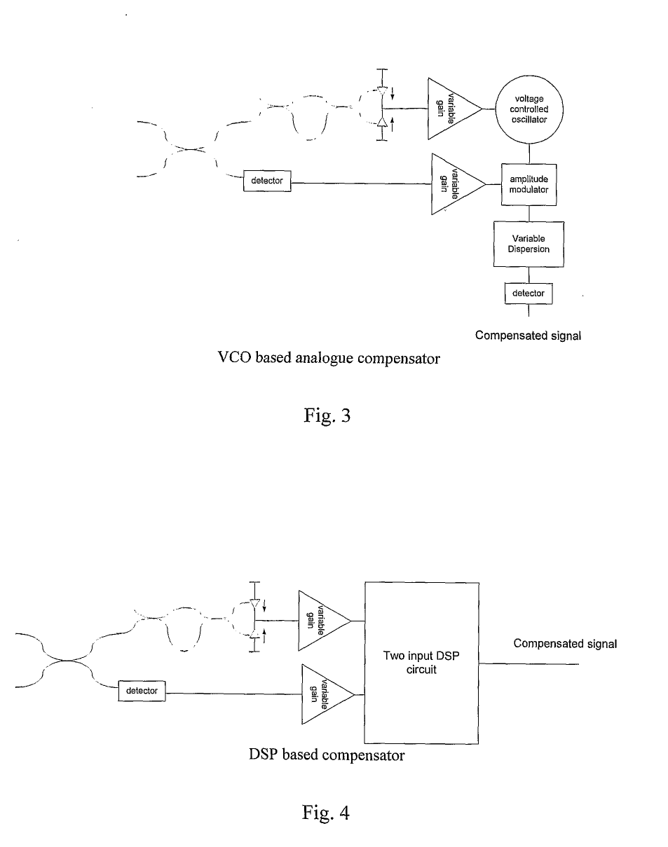

An alternative implementation is shown in FIG. 3. In this implementation the frequency modulation is achieved by directly modulating the frequency control input of a voltage controlled oscillator with the output of the differential detector.

The variable dispersion transmission line could comprise a determined length of micro strip, with tunability achieved either by probing a single transmission line along its length, or by switching different lengths of transmission line. The latter may be used, in conjunction with variations in the amplitude and frequency modulation depths, in order to provide both coarse and fine-tuning. Alternatively, for suitable carrier frequencies, the transmission line may be replaced with a FIR filter, where a simple tuning algorithm may be implemented to provide variable dispersion of the filter, in contrast to the complex filter tuning characteristics required if a FIR is used to perform dispersion compensation directly.

As frequency is more accurately represented by the ratio of the detector outputs shown in FIGS. 2 and 3 improved performance is achieved if these signals are divided prior to processing by the compensator.

### Digital Techniques

Clearly the action of the circuit, of FIGS. 2 and 3, in producing a compensated signal from the two photo current signals may be defined as a signal processing operation, and a digital signal processing circuit could be designed to perform this operation. Generically, a pair of cross-linked multi tap FIR filters should be able to generate the desired output signals as shown in FIG. 4. However, specific circuits could be designed by analysing the transfer functions achieved using the analogue compensators described above. In particular, whilst a complex cross-coupled FIR filter would require the tuning of a large number of amplitude elements, subject to feedback from the recovered signal output, a correctly designed implementation would ideally have a reduced number of tuning parameters, replicating the performance of FIGS. 2 and 3. These parameters may, of course, be used to generate a large number of control signals for each of the amplitude elements within the FIR filter; the advantage arising due to the greatly simplified control algorithm required for the reduced parameter set.

As an alternative to the arrangement of FIG. 4, two independent photo detectors at the output of the interferometer could be used to supply the inputs to the DSP circuit, with either on-chip addition and subtraction providing amplitude and phase information or the photodiode outputs being processed directly. A possible method of processing this data would be the implementation of an MLSE algorithm with multiple inputs. These inputs may either be the direct outputs of the photodiodes or the on-chip generated representation of the amplitude and phase information.

The performance of the circuit of FIG. 2 was modelled numerically using a commercial optical system simulator (VPItransmission maker). A distorted signal was generated by transmitting a 42.66 Gbit/s signal, generated using a 1553 nm cw laser and a Mach Zehnder modulator over a variable length of standard single mode fibre. For this simulation, the delay in the MZI used within the compensation device was approximately 25% of the bit period of the incoming signal, the oscillator central frequency was 193.1 THz, which was followed by a linear frequency modulator, and an amplitude modulator with a sinusoidal response (such that a small amount of distortion was generated in the circuit) and a broadband low loss transmission line was used before signal detection. This corresponded to implementing the compensation technique in the optical domain. However, this is in no way restrictive to the use of optical frequencies in any final implementation, and was simply carried out for ease of numerical simulation.

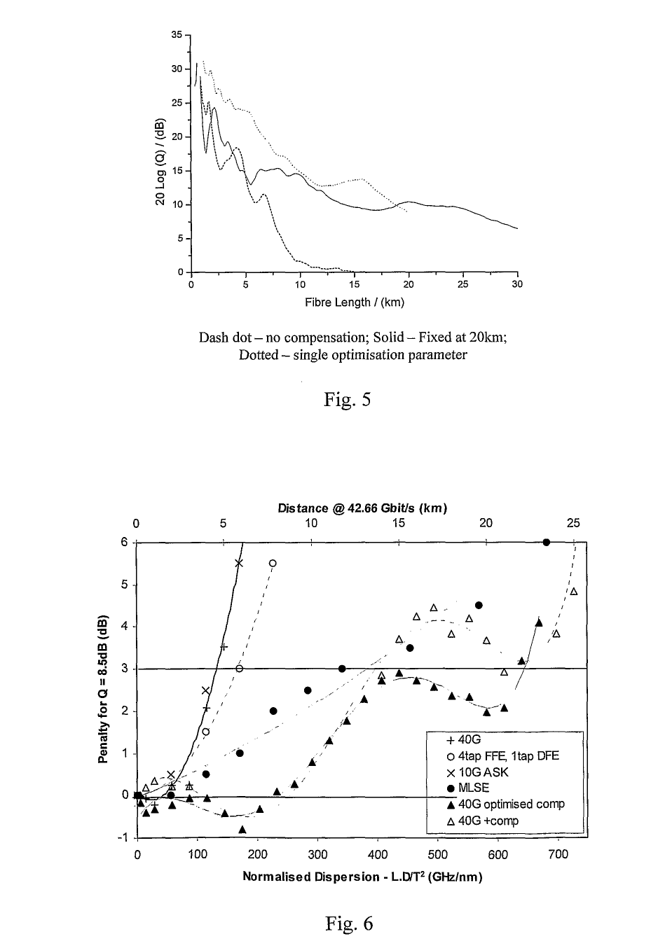

The results of the simulation may be presented either in terms of the received signal quality, or the tolerance of the signal to optical noise. Appropriate results are presented in FIGS. 5 and 6.

In FIG. 5, the eye quality, or Q factor, is plotted as a function of transmission distance, using a high chirp modulator (alpha parameter of 1). Without compensation (dash-dot curves), the eye quality degrades rapidly with transmission distance, giving a predicted error rate below 10⁻⁹ after approximately 2 km, falling below the threshold of forward error correction (FEC) by 7 km, and becoming totally closed by 10 km.

The dotted and dashed curves show the eye quality after compensation, using the high chirp modulator (worst case). The red curve shows the performance when the compensation circuit is tuned using a single tuning parameter, which controls three physical parameters of the compensator in a pre-defined fashion: the gain of the amplitude and frequency modulation, and the net dispersion of the compensating transmission line. This allows performance in excess of an error rate of 10⁻⁹ for distances up to 8 km, representing a 3 fold improvement in performance. In addition, transmission over distances of 20 km can be achieved, if the compensation technique is used in conjunction with FEC, again representing a three fold improvement.

The dashed curve shows the performance of the compensation circuit when it is tuned for optimum performance at 20 km, and remains fixed irrespective of the fibre length. In this case, whilst the performance for short distances is little improved compared to operating without the compensator, good performance is achieved for transmission distances of up to 25 km at 42.66 Gbit/s, assuming the use of FEC for a FIXED compensation device.

These results are presented in an alternative format in FIG. 6 to allow comparison with other electronic compensation techniques. To generate these plots, the optical signal to noise ratio between the signal input and the compensation device is degraded, until a Q factor of 8.5 dB is recorded. A penalty is defined as difference between the signal to noise ratio (in dB) at a particular transmission distance, and the required signal to noise ratio for a system without transmission fibre. This penalty is known as the optical signal to noise ratio penalty at a Q factor of 8.5 dB.

Following the procedure above, it is possible to compare the results obtained by numerical simulations to recently published ones (OFC 2004, papers TuG1 and 2, and PTL 16-5-pp1398), which were presented assuming the use of advanced FEC, that could translate such a quality factor into error free performance. Since the published results were presented for a data rate of 10 Gbit/s, they are plotted as a function of normalised dispersion (net dispersion divided by bit period squared). The crosses curves illustrate the system performance for 10 and 40 Gbit/s systems without any form of compensation, confirming the correct normalisation has been selected. The performance of an advanced FIR filter approach, combining a 4 tap filter with a DFE, is shown in open circles, giving a 1 dB improvement in performance, but, as expected, once the eye is closed, this technique is unable to recover the signal. Results from an MLSE proof of concept experiment are shown in closed circles. In this case, the signal may be recovered from a closed eye, and the transmission distance is more than doubled. Results using this invention are shown in open triangles (for a compensator tuned for 20 km, and then fixed) and closed triangles (for a compensator tuning using a single tuning parameter). At all distances, the proposed technique outperforms MLSE, and 20 km transmission at 42.66 Gbit/s is readily achieved. This is equivalent to a transmission distance of 360 km at 10 Gbit/s.

TABLE 1

| | Compensation | Tuning | Wavelength | |
|---|---|---|---|---|
| | range | Complexity | sensitivity | Cost |
| DCF | Unlimited | No tuning | Very low | High |
| | | possible | | |
| Tunable optical | Unlimited | Low | Very high | High |
| FIR/FIR-DFE | Small | Medium | None | Low |
| MLSE | Large | Very high | None | Low |
| Heterodyne | Large | Very high | Very high | High |
| detection | | | | |
| Invention | Large | Low-, | None | Low |

Table 1 above is a summary of the advantages of this invention. This invention offers a large tuning range, with a very low tuning complexity (fixed configuration, or controlled by a single parameter) for all signal wavelengths. It may be implemented at low cost using a two-input DSP circuit, or at slightly higher cost using analogue techniques.

The invention may be extended to compensate for PMD by, for example, using a beam splitter, and two compensation devices.

In addition to providing dispersion compensation at the end of a transmission line, this invention may also be used to provide a high degree of dispersion tolerance for all optical regenerators, as illustrated by the numerical demonstration.

The invention is not limited to the embodiments described but may be varied in construction and detail.

1-22. (canceled)

23. A dispersion compensation system comprising a detector for receiving a distorted optical input signal and a compensator for processing the detector outputs and re-constituting an original signal of the distorted optical signal, wherein:
the detector generates at least two electronic signals which depend on the instantaneous amplitude and frequency of the distorted signal in different ways, wherein the detector comprises a wavelength selective device and two or more opto-electronic components providing the electrical signals; and
the compensator using amplitude and frequency information in the detector output to perform compensation of the dispersion of the optical signal, and re-constituting the original signal.

24. The dispersion compensation system as claimed in claim 23, wherein the wavelength selective device comprises a Mach Zehnder interferometer.

25. The dispersion compensation system as claimed in claim 24, wherein the detector subtracts outputs of the interferometer to provide frequency information.

26. The dispersion compensation system as claimed in claim 24, wherein the detector sums interferometer outputs to provide amplitude information.

27. The dispersion compensation system as claimed in claim 23, wherein the detector comprises a dedicated amplitude-detecting component.

28. The dispersion compensation system as claimed in claim 23, wherein the compensator comprises a local oscillator which is modulated by amplitude, phase, or frequency information of the detector output signals.

29. The dispersion compensation system as claimed in claim 28, wherein the local oscillator operates in the range of 11 to 100 GHz.

30. The dispersion compensation system as claimed in claim 28, wherein the local oscillator comprises a laser device.

31. The dispersion compensation system as claimed in claim 28, wherein the amplitude modulation in the compensator is non-linear, and the non-linearity is engineered to improve performance.

32. The dispersion compensation system as claimed in claim 28, wherein frequency modulation is performed in a separate device of the compensator.

33. The dispersion compensation system as claimed in claim 32, wherein said device is an I/Q modulator, a double balanced mixer, or an acousto-optic device.

34. The dispersion compensation system as claimed claim 28, wherein the compensator comprises a phase modulator for converting frequency information to phase information prior to modulation of the local oscillator.

35. The dispersion compensation system as claimed in claim 28, wherein the compensator comprises a phase modulator for converting frequency information to phase information prior to modulation of the local oscillator; and wherein the phase modulator comprises a device with a Kerr non-linearity.

36. The dispersion compensation system as claimed in claim 28, wherein the compensator comprises a phase modulator for converting frequency information to phase information prior to modulation of the local oscillator; and wherein the phase modulator comprises a semiconductor device.

37. The dispersion compensation system as claimed in claim 28, wherein the local oscillator is directly frequency modulated by a detector output signal.

38. The dispersion compensation system as claimed in claim 28, wherein the local oscillator is directly frequency modulated by a detector output signal; and wherein the local oscillator is a voltage controlled oscillator; a current controlled oscillator; or a semiconductor laser, preferably with the alpha parameter greater than 4.

39. The dispersion compensation system as claimed in claim 28, wherein the compensator transmits the modulated local oscillator along a dispersive transmission line such as a micro-strip, an amplifier, an optical fibre, a grating, and/or an FIR filter.

40. The dispersion compensation system as claimed in claim 23, wherein the compensator comprises a two-input electrical filter, such as a pair of cross-coupled FIR filters, or a DSP such as an FPGA.

41. The dispersion compensation system as claimed in claim 23, wherein the compensator comprises a two-input electrical processing unit with past state- or sequence-based decision making such by executing an MLSE algorithm.

42. The dispersion compensation system as claimed in claim 23, wherein the compensator comprises a two-input electrical filter, such as a pair of cross-coupled FIR filters, or a DSP such as an FPGA; and wherein the filter simulates the performance of a local oscillator.

43. The dispersion compensation system as claimed in claim 23, wherein the compensator processes the outputs of the detector to provide signals proportional to the amplitude and frequency of the distorted signal, and re-constitutes the original signal using the processed signals.
